(19) United States
(12) Patent Application Publication
(10) Pub. No.: US 2018/0225831 A1
(43) Pub. Date: Aug. 9, 2018

(54) IMAGE PROCESSING DEVICE, IMAGE RESTORING DEVICE, AND IMAGE PROCESSING METHOD

(71) Applicant: NEC Corporation, Minato-ku, Tokyo (JP)

(72) Inventor: Eiji MURAMATSU, Tokyo (JP)

(73) Assignee: NEC Corporation, Minato-ku, Tokyo (JP)

(21) Appl. No.: 15/746,847

(22) PCT Filed: Aug. 3, 2016
(86) PCT No.: PCT/JP2016/072864

§ 371 Date: Jan. 23, 2018

(30) Foreign Application Priority Data
Aug. 7, 2015 (JP) 2015-157725

(51) Int. Cl. G06T 7/194; G06T 7/174; G06T 11/00; G06K 9/00; H04L 9/14; H04L 9/08; G06F 21/60; G06F 21/62

(52) U.S. Cl. CPC G06T 7/194; G06T 7/174; G06T 11/00; G06F 21/6245; H04L 9/14; H04L 9/0861; G06F 21/602; G06K 9/00268

(57) ABSTRACT

The present invention provides an image processing an image processing device. The image processing device obtains first image including a specific object such as confidential documents or a person, and generate second image such that the particular object is encrypted. Then, the image processing device outputs first image or second image according to the viewer's attribute. This achieves protection of the secret object appearing in first image while the viewer is able to referring to the image freely.

### TECHNICAL FIELD

The present invention relates to a device and a method for processing and restoring an image captured with a monitoring camera, and especially relates to a system for protecting a privacy of a subject in the captured image.

This application claims priority based on Japanese Patent Application No. 2015-157725 filed on Aug. 7, 2015, the disclosure of which is incorporated herein in its entirety.

### BACKGROUND ART

In recent years, a monitoring camera is installed to a station yard, a commercial architecture, a cluster housing and the like and a person image is monitored to facilitate an improvement of the security. However, since a face of a person of the cluster housing may be displayed in the image captured by the monitoring camera, when the captured image is provided to a third party (for example, security company, police organization or the like), it is needed to consider the privacy protection.

Conventionally, a technique of controlling the disclosure and the concealment of specific information by conducting the encryption or the decryption to image information captured by the monitoring camera is developed. PTL 1 discloses a monitoring camera system that properly protects the privacy of the subject and can realize the monitoring function. Among the captured images of the monitoring camera, the video portion including the specific subject is encrypted, and thus the browse of the video portion including the subject is limited to concerned parties. PTL 2 discloses a sentence processor that sets degrees of secrecy to the desired portion of the electronic document and conceals the contents. A plurality of portions of the electronic document are, for each disclosure standard, encrypted using different encryption keys, to allow the degrees of the secrecy to be set to individual portions to conceal the contents. PTL 3 discloses a medical image encryption device that conducts the encryption such that the recognition of the appearance of the medical image is difficult and can differentiate the degrees of the disclosure depending on the destination. PTL 4 discloses a monitoring camera video distribution system that can distribute the video for allowing the recognition of the visit situation while protecting the image right or the privacy of the customer visiting the shop. PTL 5 discloses a monitoring device and a monitoring method that allow the privacy protection of the monitoring area. The image data of the mask area can be eliminated from the video captured with the monitoring camera.

### CITATION LIST

### Patent Literature

[PTL 1] International Publication No. WO2006/115156

[PTL 2] Japanese Unexamined Patent Publication (Kokai) No. 2008-193612

[PTL 3] Japanese Unexamined Patent Publication (Kokai) No. 2007-243256

[PTL 4] Japanese Unexamined Patent Publication (Kokai) No. 2005-236464

[PTL 5] Japanese Unexamined Patent Publication (Kokai) No. 2003-61076

### SUMMARY OF INVENTION

### Technical Problem

The video appearing to the monitoring camera is used for various use applications (for example, search of loss product, marketing, specification of suspicious person and the like). However, in the video in which a part is concealed by a technique disclosed in above described patent literatures, the information content is reduced, and thus, the use application is limited. For example, it is difficult to apply the video, in which all persons are masked, to the use application for identifying the suspicious person. On the other hand, when the video, in which the encryption is released, is disclosed, private information unnecessary for a third party can be browsed, and it becomes difficult to sufficiently protect the privacy of the person. In other words, according to the technique disclosed in the above described patent literatures, when the video is encrypted for the purpose of information concealment, disclosure information becomes much reduced, and when the video is decrypted, the disclosure information becomes excessive.

As above, in the prior art, it has been difficult to adjust the disclosure and the concealment of the information by the encryption/decryption of the video depending on the use application.

The present invention is made to solve the above described problems. An object of the present invention is to provide an image processing device, an image restoring device, an image processing method and an image restoring method that can adjust the information content by processing and restoring the image captured with the monitoring camera depending on the purpose of use.

### Solution to Problem

An aspect of the invention is an image processing device. The image processing device comprises changed image generating means and output means. The changed image generating means for generating a second image obtained by changing a specific subject included in a first image. The output means outputs either one of the first image or the second image depending on a viewer.

Another aspect of the invention is an image processing method. The image processing method comprises generating a second image obtained by changing a specific subject included in a first image, and outputting either one of the first image or the second image depending on a viewer.

Another aspect of the invention is an image processing system. The image processing system comprises a first information processing device and a second information processing device. The first information processing device changes a specific subject included in a first image to generate a second image and conducts an image recording process of recording the first image and the second image. The second information processing device conducts an image providing process of outputting either one of the first image or the second image depending on a viewer.

### Advantageous Effects of Invention

According to the image processing device of the present invention, attribute information of the area of the first image (image before change) in which the specific subject is appeared is changed to generate the second image (changed image) and either one of the first image and the second image is output depending on the viewer. Further, image restoring device combines the background image obtained by eliminating, from the first image, the subject image and outputs the second image. In other words, by adjusting the information content of the changed image depending on the purpose of use of the viewer, the protection of the privacy of the individual can be facilitated.

### BRIEF DESCRIPTION OF DRAWINGS

FIG. 1 is a block diagram of an image processing system according to an embodiment 1 of the present invention.

FIG. 2 is a flowchart illustrating an image recording process of a cloud server mounted to the image processing system according to the embodiment 1.

FIG. 3 is a flowchart illustrating an image providing process of the cloud server mounted to the image processing system according to the embodiment 1.

FIG. 4 is a block diagram of an image processing system according to the embodiment 2 of the present invention.

FIG. 5 is a flowchart illustrating an image providing process of the cloud server mounted to the image processing system according to the embodiment 3 of the present invention.

FIG. 6 is a block diagram of an image processing system according to the embodiment 4 of the present invention.

FIG. 7 is a flowchart illustrating an image providing process of the cloud server mounted to the image processing system according to the embodiment 4 of the present invention.

FIG. 8 is a block diagram illustrating a basic configuration of an image processing device according to the present invention.

FIG. 9 is a flowchart illustrating basic process of an image processing method according to the present invention.

FIG. 10 is a block diagram illustrating a basic configuration of an image restoring device according to the present invention.

FIG. 11 is a flowchart illustrating basic process of an image restoring method according to the present invention.

FIG. 12 is a block diagram of a computer that can implement an image processing function and an image restoration function of the present invention.

### DESCRIPTION OF EMBODIMENTS

With reference to accompanying drawings, the image processing device, the image restoring device, the image processing method and the image restoring method of the present invention are described in details with embodiments.

### Embodiment 1

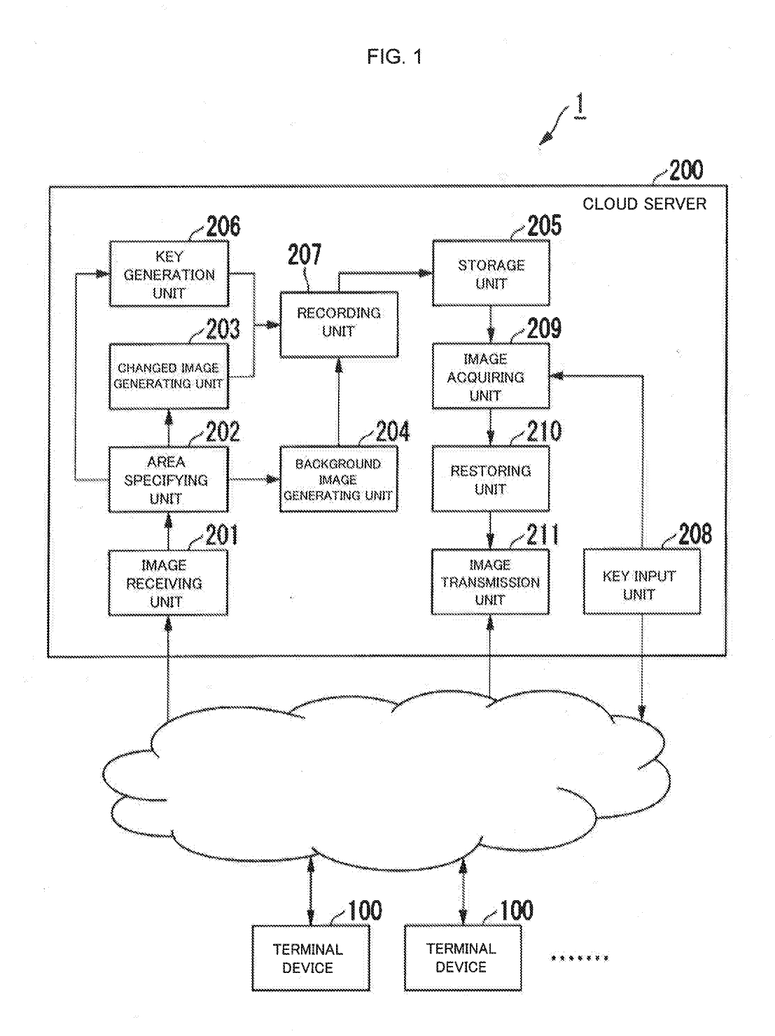

FIG. 1 is a block diagram of an image processing system 1 according to the embodiment 1 of the present invention. The image processing system 1 includes a terminal device 100 and a cloud server 200. The terminal device 100 includes at least either one of an imaging device or a display device. Examples of the terminal device 100 include a monitoring camera, a personal computer (PC), a mobile phone, and a TV apparatus.

The cloud server 200 stores image data captured by the terminal device 100. Herein, the “image data” includes still image and moving image having a plurality of frames. The cloud server 200 transmits the stored image data to the terminal device 100. The cloud server 200 is one example of the image processing device and the image restoring device. The cloud server 200 may be realized by a single device or a plurality of devices through joint by using a virtualization technology. Note that the terminal device 100 and the cloud server 200 are connected via the network such as Internet.

The cloud server 200 includes an image receiving unit 201, an area specifying unit 202, a changed image generating unit 203, a background image generating unit 204, a storage unit 205, a key generation unit 206, a recording unit 207, a key input unit 208, an image acquiring unit 209, a restoring unit 210, and an image transmission unit 211.

The image receiving unit 201 receives, from the terminal device 100, the image data. The image data is one example of “the first image” specified in CLAIMS. The area specifying unit 202 identifies or specifies, in the image data received by the image receiving unit 201, a predetermined area in which a predetermined target is appeared (hereinafter referred to as “target area”). Examples of the target include moving objects such as a person, an animal, and a vehicle. The area specifying unit 202, for example, by conducting the pattern matching between the template of the target prepared in advance and the image data, identifies or specifies the area in which the target is appeared.

The changed image generating unit 203 changes the area specified by the area specifying unit 202 in a predetermined manner and generates a plurality of changed images. Through the change process by the changed image generating unit 203, at least a part of pieces of attribute information of the target may not be read. It is assumed that a plurality of images can recognize different attributes of respective targets (not limited to totally different attribute, but may be partially duplicated attribute). Examples of the change process by the changed image generating unit 203 include the followings.

(1) The changed image generating unit 203 may replace the target appeared in the area specified by the area specifying unit 202 to the silhouette. Accordingly, the changed image generating unit 203 can generate the changed image allowing the identification of kinds of the target (for example, person, animal, vehicle and the like).
(2) The changed image generating unit 203 may replace the image of the area specified by the area specifying unit 202 to an image displaying attribute information (for example, gender, age, body height and the like) of the target appeared in the area. Accordingly, the changed image generating unit 203 can generate the changed image through which the attribute information of the target can be specified.
(3) The changed image generating unit 203 can reduce the definition of the area specified by the area specifying unit 202. Accordingly, the changed image generating unit 203 can generated the changed image that can identify the color of the target.
(4) The changed image generating unit 203 may mask a part of the target appeared in the area specified by the area specifying unit 202 (for example, face of person, license plate of vehicle and the like). Accordingly, the changed image generating unit 203 can generate the changed image by which the kind of clothes of the target person and the type of vehicle can be identified.

The background image generating unit 204 generates the background image by eliminating, from the image data received by the image receiving unit 201, the area specified by the area specifying unit 202. The background image generating unit 204, for example, combines the target image data with the image of other frames in which the target is not present in the area so that the specified area is eliminated from the image data. Further, the background image generating unit 204 applies the pixel set around the specified area to the area so that the specified area can be eliminated. The background image generating unit 204, can use, for example, the image of other frames in which the target is not present as the background image.

The storage unit 205 stores a plurality of changed images generated by the changed image generating unit 203, the image before undergoing the change process by the changed image generating unit 203 (hereinafter referred to as “image before change”) and the background image generated by the background image generating unit 204. A position in which the image is extracted is associated with the changed image and the image before change. Further, the changed image and the image before change are respectively encrypted using different encryption keys and the encrypted images are stored in the storage unit 205. Note that when the image data represents the moving image, the storage unit 205 may store the changed image, the image before change, and the background image for each frame. Alternatively, the storage unit 205 may store the changed image, the image before change, and the background image respectively as moving images.

The key generation unit 206, based on the changed image and the image before change, generates the encryption key. For example, the key generation unit 206, based on the feature quantity of the target included in the image before change (for example, feature quantity of person face, character string of license plate of vehicle and the like), generates the encryption key. The recording unit 207 encrypts the changed image generated by the changed image generating unit 203 using a predetermined encryption key. The recording unit 207 encrypts the image before change using the encryption key generated by the key generation unit 206. The recording unit 207 records, to the storage unit 205, the encrypted changed image, the image before change, and the background image.

The key input unit 208 receives the encryption key input to the terminal device 100. The image acquiring unit 209, among the changed images stored by the storage unit 205, acquires the changed image that can be restored using the encryption key that is input to the key input unit 208 and the background image. The restoring unit 210 combines the changed image acquired by the image acquiring unit 209 and the background image so as to generate image data for disclosure. The image data for disclosure is one example of “the second image” specified in CLAIMS. The image transmission unit 211 transmits the presentation image data generated by the restoring unit 210 to the terminal device 100. Note that the image transmission unit 211 is one example of the “output unit” specified in CLAIMS.

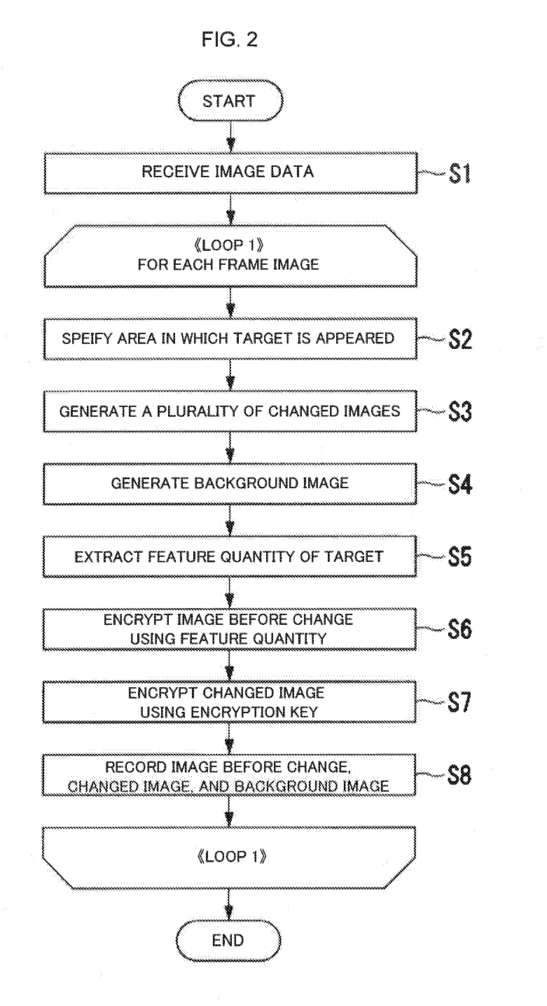

Next, operations of the cloud server 200 are described with reference to the flowchart of FIG. 2. Here, through the cloud server 200, the procedure of recording the image data captured by the terminal device 100 is described. FIG. 2 is the flowchart illustrating the image recording process by the cloud server 200.

First, the image data captured by the terminal device 100 is transmitted to the cloud server 200. The image receiving unit 201 of the cloud server 200 receives the image data (step S1). The area specifying unit 202, for each frame included in the image data, conducts step S2 to step S8. Note that when the image data is the still image, step S2 to step S8 are conducted once.

The area specifying unit 202 identifies or specifies in the image of the frame of the processing target, the area in which the target is appeared (step S2). When a plurality of targets is appeared in the image of the frame of the processing target, the area specifying unit 202 respectively specifies the area including each target. Next, the changed image generating unit 203 conducts a plurality of types of change processes to each area specified by the area specifying unit 202 and generates a plurality of changed images (step S3). In the present embodiment, the changed image generating unit 203 conducts the following four processes to the area specified by the area specifying unit 202.

(1) A process of extracting the silhouette of the target.
(2) A process of replacing an image to an image representing the gender of the target.
(3) A process of replacing an image to an image representing the age of the target.
(4) A process of lowering the definition.

Next, the background image generating unit 204 eliminates, from the image of the frame of the processing target, the area specified by the area specifying unit 202 and generates the background image (step S4). When the area specifying unit 202 identifies or specifies a plurality of areas, the area specifying unit 202 eliminates all areas from the image of the frame of the processing target.

Next, the key generation unit 206 extracts, from the image before change of each area specified by the area specifying unit 202, the feature quantity of the target (step S5). The recording unit 207 uses the feature quantity generated by the key generation unit 206 as the encryption key and encrypts the image before change (step S6). Thereafter, the recording unit 207 encrypts the changed image generated by the changed image generating unit 203 for each change process by using the common encryption key (step S7). Common keys used for the encryption of the changed image include the encryption key of the silhouette image, the encryption key of the low-definition image, the encryption key for each gender, and the encryption key for each age. For example, the recording unit 207 encrypts the changed image representing the gender of the target using the encryption key in accordance with the gender of the target.

Next, the recording unit 207 records, to the storage unit 205, a plurality of encrypted images before change, the changed image, and the background image (step S8). The recording unit 207 associates coordinates and the frame number to which the image before change and the changed image should be arranged with the image before change, the changed image, and the background image and records the coordinates and the frame number to the storage unit 205.

According to the above described procedure, the cloud server 200 can, depending on the purpose of use, adjust the disclosure amount of the attribute information of the target and construct a database for presenting the image data.

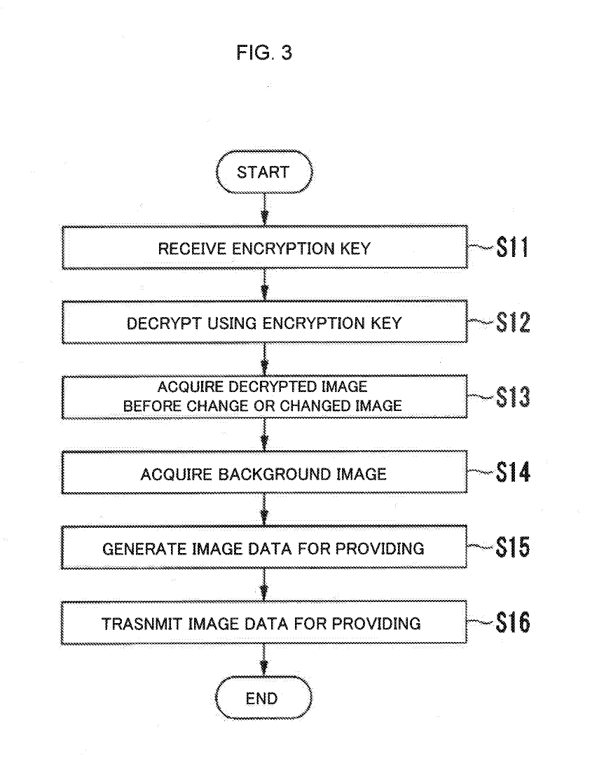

Next, the procedure for the cloud server 200 for, based on the request of the terminal device 100, providing the image data is described. FIG. 3 is the flowchart illustrating the image providing process by the cloud server 200.

When a user wishes to browse the image data via the terminal device 100, the user inputs, to the terminal device 100, the encryption key depending on the information in which the user wishes to browse. When the encryption key is input by the user, the terminal device 100 transmits the encryption key to the cloud server 200.

The key input unit 208 of the cloud server 200 receives, from the terminal device 100, the encryption key (step S11). The image acquiring unit 209 attempts the decryption of all the images before change and the changed images stored in the storage unit 205 using the encryption key (step S12). The image acquiring unit 209, among the images before change and the changed images stored by the storage unit 205, for each area and for each frame, acquires an image that is successful in the decryption (step S13). Note that as a result of the attempt of the decryption by the image acquiring unit 209 using a plurality of encryption keys, when with respect to the same frame of the same area, the decryptions of a plurality of images are successful, the image acquiring unit 209 acquires the image having the largest pieces of attribute information that can be specified. The amount of the attribute information that can be specified is the largest for the image before change and, and among the pieces of changed image, the smallest for the silhouette image. The image acquiring unit 209 acquires the background image of each frame stored by the storage unit 205 (step S14).

Next, the restoring unit 210, combines the background image of each frame acquired by the image acquiring unit 209 with the image before change for each area concerning the frame or the changed image, and generates image data combined for providing (step S15). Specifically, the restoring unit 210, among the pieces of background image, to the coordinates stored by the storage unit 205, arranges the image before change or the changed image so as to generate the image data for providing. In other words, the restoring unit 210 generates the image data for providing using the changed image through which the attribute information of the subject specified by the encryption key can be recognized. The image transmission unit 211 transmits the image data for providing generated by the restoring unit 210 to the terminal device 100, i.e., the transmitter of the encryption key (step S16).

Upon receiving, from the cloud server 200, image data for providing, the terminal device 100 causes the display to display the image data for providing. Accordingly, the user can browse the desired image.

In this manner, according to the above described procedure, the cloud server 200, depending on the purpose of use, can adjust the disclosure amount of the attribute information of the target and present the image data to the user. For example, the image processing system 1, to the user who wishes to use the image data for the marketing, can provide the encryption key for each gender and the encryption key for each age. Accordingly, by using the image processing system 1, the user can specify the gender or the age of the person appearing in the image data. On the other hand, the image processing system 1 can prevent the attire or the face of the person appearing in the image data from being recognized by the user.

The image processing system 1 can provide, to a user who wishes to search a certain person, the encryption key extracted from the face feature quantity of the person. Accordingly, by using the image processing system 1, the user can browse the detailed image of the search target appearing in the image data. On the other hand, the image processing system 1 can prevent other persons appearing to the image data from being recognized by the user.

### Embodiment 2

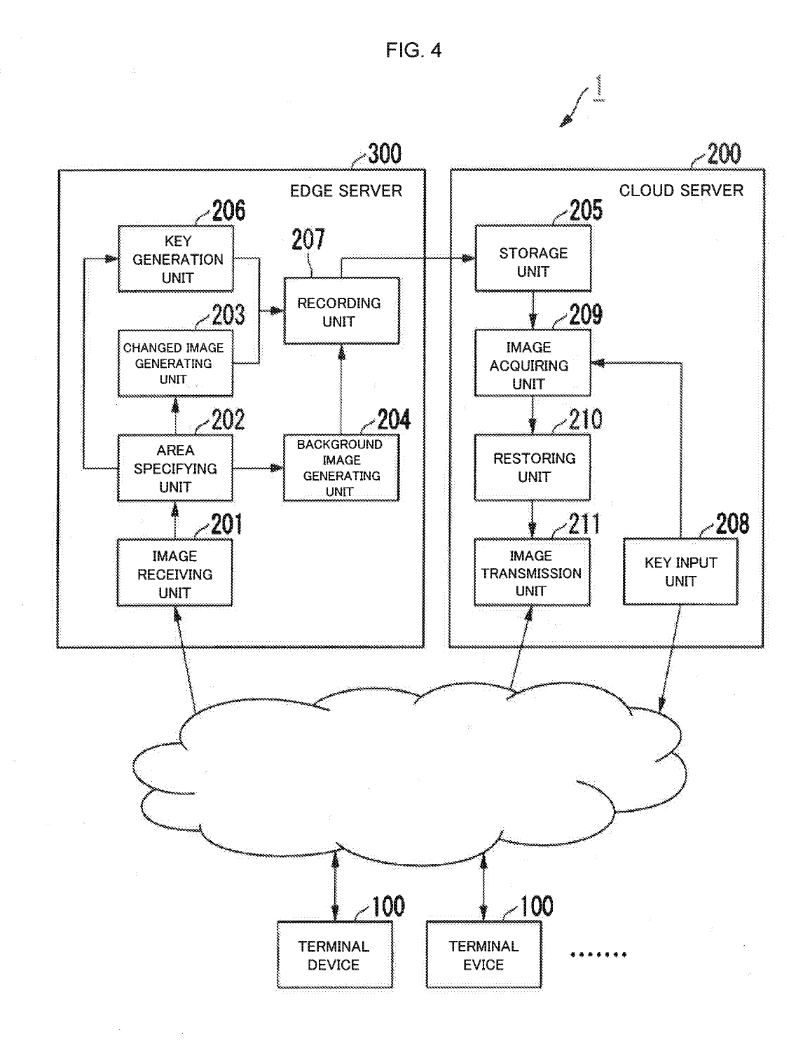

The embodiment 2 of the present invention is described with reference to FIG. 4. In the image processing system 1 according to the embodiment 1, the cloud server 200 conducts the registration process of the image and the providing process of the image. On the other hand, in the image processing system 1 according to the embodiment 2, a device other than the cloud server 200 conducts the registration process of the image.

FIG. 4 is a block diagram of the image processing system 1 according to the embodiment 2 of the present invention. The image processing system 1 according to the embodiment 2 includes the terminal device 100, the cloud server 200, and an edge server 300. The edge server 300, to suppress the load applied to the cloud server 200, conducts the preprocessing to the data transmitted by the terminal device 100. Specifically, the edge server 300 includes the image receiving unit 201, the area specifying unit 202, the changed image generating unit 203, the background image generating unit 204, the key generation unit 206, and the recording unit 207. Further, the cloud server 200 includes the storage unit 205, the key input unit 208, the image acquiring unit 209, the restoring unit 210, and the image transmission unit 211. Although in the embodiment 2, components 201 to 211 are dispersed and arranged to the cloud server 200 and the edge server 300, the components have equivalent functions as those of components 201 to 211 of the cloud server 200 according to the embodiment 1. Note that the recording unit 207 of the edge server 300 records the above described image to the storage unit 205 of the cloud server 200.

As described above, in the image processing system 1 according to the embodiment 2, the edge server 300 conducts the registration process of the image and the cloud server 200 conducts the providing process of the image. The cloud server 200 according to the embodiment 2 is one example of the image restoring device specified in CLAIMS. In this manner, the image processing system 1 according to the embodiment 2 causes the edge server 300 to share the registration process of the image having the high processing load so as to suppress the load of the cloud server 200.

Although in the present embodiment, the edge server 300 conducts the registration process of the image and the cloud server 200 conducts the providing process of the image, the embodiment is not limited to this. For example, by modifying the present embodiment, a part of the providing process of the image may be conducted by the edge server 300 and a part of the registration process of the image may be conducted by the cloud server 200. Alternatively, the image processing may be shared between the cloud server 200 and the terminal device 100.

Note that the cloud server 200 is one example of a first information processing device specified in CLAIMS, and the edge server 300 and the terminal device 100 are one example of a second information processing device specified in CLAIMS. In other words, the cloud server 200, i.e., the first information processing device and the edge server 300, i.e., the second information processing device may share the image processing. Alternatively, the cloud server 200, i.e., the first information processing device and the terminal device 100, i.e., the second information processing device may share the image processing.

### Embodiment 3

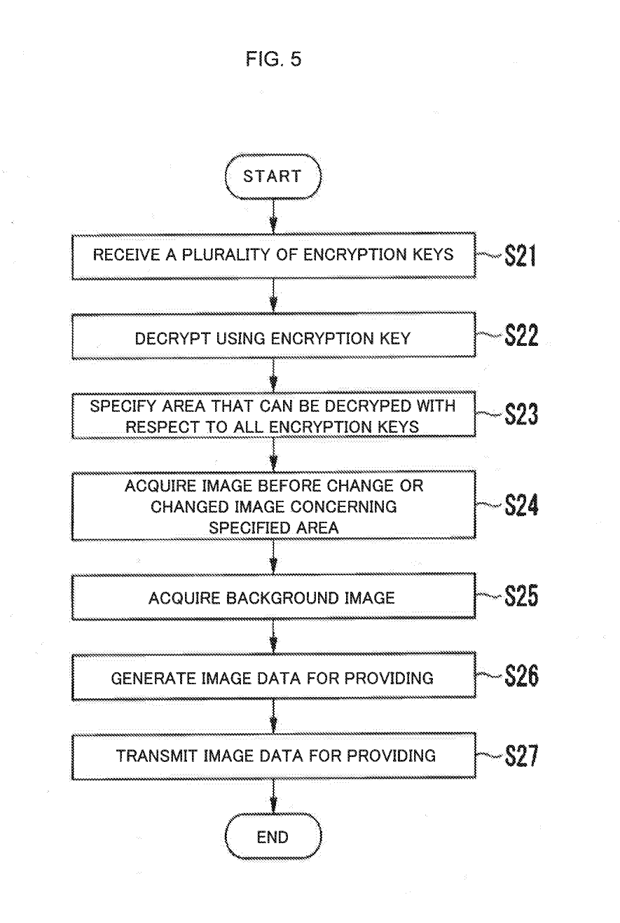

Next, the embodiment 3 of the present invention is described with reference to FIG. 5. The cloud server 200 mounted to the image processing system 1 according to the embodiment 1 and the embodiment 2, with respect to all areas in which the image that is successful in the decryption is present, generates the image data for providing using the image. On the other hand, the cloud server 200 mounted to the image processing system 1 according to the embodiment 3, when a plurality of encryption keys is input, only with respect to the area in which the decryption is successful using all encryption keys, generates the image data for providing using the image.

The image processing system 1 according to the embodiment 3 has a configuration similar to that of the image processing system 1 according to the embodiment 1. However, the image processing system 1 according to the embodiment 3 differs from the image processing system 1 according to the embodiment 1 in the providing process of the image. FIG. 5 is the flowchart illustrating the image providing process by the cloud server 200 according to the embodiment 3.

When a user, via the terminal device 100, browses the image data, the user inputs the encryption key to the terminal device 100 depending on information in which the user wishes to browse. At this time, the user inputs, to the terminal device 100, a plurality of encryption keys associated with the attribute information of the target to be displayed. For example, when the target to be displayed is a male in his thirties, the user inputs, to the terminal device 100, the encryption key associated with male's thirties and the encryption key associated with male. When the terminal device 100 receives the encryption key by the user, the terminal device 100 transmits the encryption key to the cloud server 200.

The key input unit 208 of the cloud server 200 receives, from the terminal device 100, the encryption key (step S21). Next, the image acquiring unit 209 attempts the decryption of all of the images before change and the changed images stored by the storage unit 205 using the encryption key (step S22). The image acquiring unit 209, among the areas including the target, identifies or specifies the area including all changed images which can be decrypted using each encryption key (step S23). For example, when the key input unit 208 receives the encryption key associated with male's thirties and the encryption key associated with male, the image acquiring unit 209 specifies the area linked to the changed image that can be decrypted using the encryption key associated with male's thirties and the changed image that can be decrypted using the encryption key associated with male. Thereafter, the image acquiring unit 209 acquires, from the storage unit 205, the image before change or the changed image concerning the specified area (step S24). At this time, the image acquiring unit 209, with respect to the same area, acquires the image having the largest pieces of attribute information that can be specified. Further, the image acquiring unit 209 acquires the background image of each frame stored by the storage unit 205 (step S25).

Next, the restoring unit 210 combines the background image acquired by the image acquiring unit 209 with the image before change or the changed image acquired at step S24 to generate the image data for providing (step S26). In other words, the restoring unit 210 generates the image data for providing using the changed image that can recognize the attribute information of the subject specified by the encryption key. The image transmission unit 211 transmits the image data for providing generated by the restoring unit 210 to the terminal device 100, i.e., the transmitter of the encryption key (step S27).

Upon receiving, from the cloud server 200, the image data for providing, the terminal device 100 causes the display to display the image data for providing. Accordingly, the user can browse the desired image. In this manner, the cloud server 200 according to the present embodiment can generate the image data for providing in which the target satisfying all conditions of the input encryption key is appeared. Accordingly, the user can effectively search the search target using the image data for providing.

### Embodiment 4

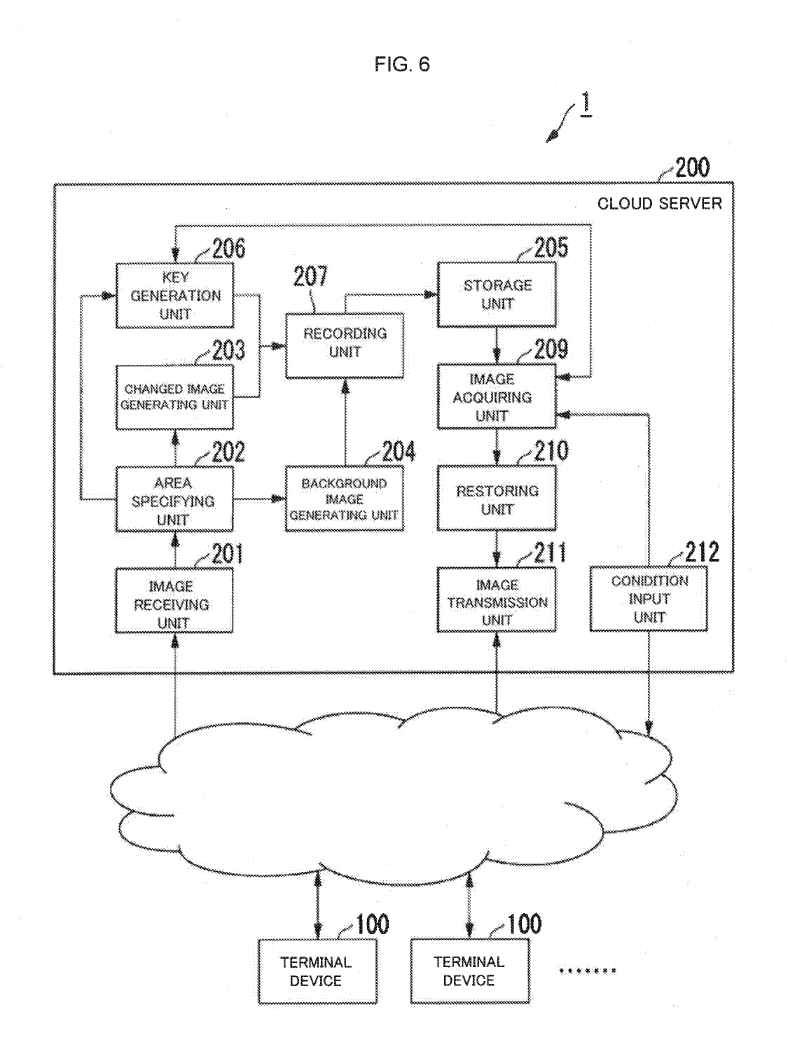

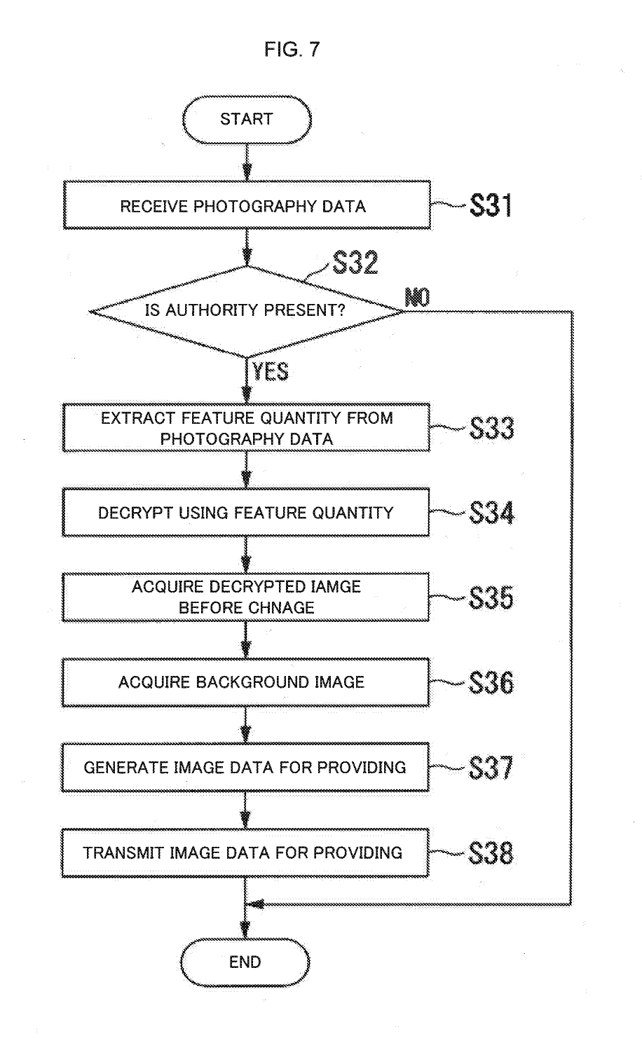

Next, the image processing system 1 according to the embodiment 4 of the present invention is described with reference to FIG. 6 and FIG. 7. The cloud server 200 according to the embodiment 1 to the embodiment 3 generates the image data for providing using the encryption key received from the terminal device 100. On the other hand, the cloud server 200 according to the present embodiment uses image data instead of the encryption key and generates the image data for providing in which the target appearing in the image data is appeared.

FIG. 6 is a block diagram of the image processing system 1 according to the embodiment 4 of the present invention. While the cloud server 200 according to the embodiment 4 includes a condition input unit 212, the cloud server 200 according to the embodiment 1 includes the key input unit 208. Therefore, while the cloud server 200 according to the embodiment 4 includes components identical with components 201 to 207 and 209 to 211 of the cloud server 200 according to the embodiment 1, the cloud server 200 according to the embodiment 4 differs from the cloud server 200 according to the embodiment 1 in the operations of the key generation unit 206 and the image acquiring unit 209. The condition input unit 212 receives, from the terminal device 100, the image data in which the target is appeared.

Next, a procedure for the cloud server 200 according to the embodiment 4 for, in response to the request of the terminal device 100, providing the image data is described. FIG. 7 is the flowchart illustrating the image providing process by the cloud server 200 according to the embodiment 4.

When the user, via the terminal device 100, browses the image data, the user inputs the image data, in which the target to be displayed is appeared, to the terminal device 100. When the terminal device 100 receives the image data by the user, the terminal device 100 transmits the image data to the cloud server 200.

First, the condition input unit 212 of the cloud server 200 receives, from the terminal device 100, the image data (step S31). Next, the image acquiring unit 209 refers to the authority information of the user and based on the image data, determines whether the user has the authority to browse the image before change of the target (step S32). Specifically, the image acquiring unit 209, based on the user's login information to the image processing system 1, determines whether the user has the authority. For example, when the user is a police officer having the investigative authority, the image acquiring unit 209, based on the image data, determines that the user has the authority to browse the image before change of the target. When the image acquiring unit 209 determines that the user does not have the authority (determination result of step S32 “NO”), the image acquiring unit 209 ends the image providing process without generating the image data for providing.

On the other hand, when the user has the authority (determination result of step S32 “YES”), the key generation unit 206 extracts the feature quantity of the target from the image data input to the condition input unit 212 (step S33). Next, the image acquiring unit 209, with respect to all of the images before change stored by the storage unit 205, by assuming the feature quantity of the target extracted from the image data as the encryption key, attempts the decryption of the image data (step S34). Thereafter, the image acquiring unit 209, among the images before change stored by the storage unit 205 for each area and for each frame, acquires the image before change which is successful in the decryption (step S35). Further, the image acquiring unit 209 acquires the background image of each frame stored by the storage unit 205 (step S36).

Next, the restoring unit 210 combines the background image of each frame acquired by the image acquiring unit 209 with the changed image for each area concerning the frame, to generate the image data for providing (step S37). Specifically, the restoring unit 210, in the background image, to the coordinates stored by the storage unit 205, arranges the image before change so as to generate the image data for providing. In other words, the restoring unit 210 generates the image data for providing by using the changed image that can recognize the attribute information of the subject specified by the image data. The image transmission unit 211 transmits the image data for providing generated by the restoring unit 210 to the terminal device 100, i.e., the transmitter of the encryption key (step S38).

Upon receiving, from the cloud server 200, the image data for providing, the terminal device 100 causes the display to display the image data for providing. Accordingly, the user can browse the desired image. In this manner, according to the above described procedure, the cloud server 200, based on the image data input by the user, can provide, to the user, the image data in which the target appearing to the image data is appeared.

With reference to FIG. 1 to FIG. 7, with the embodiment 1 to the embodiment 4, although the image processing system 1 according to the present invention is described in details, specific configurations are not limited to the above described embodiments, and various design changes are possible. For example, although the image processing system 1 encrypts the changed image and the image before change and stores the encrypted images to the storage unit 205, an embodiment is not limited to this. By modifying the above described embodiments, the image processing system 1 may store the changed image and the image before change to the storage unit 205 in the plain sentence. Alternatively, the image processing system 1 may encrypt the image before change, store the encrypted image to the storage unit 205, and store the changed image to the recording unit 207 in the plain sentence.

Although the image processing system 1 in the above described embodiments combines the background image with the changed image or the image before change to generate the image data for providing, an embodiment is not limited to this. For example, the image processing system 1 may generate the image data for providing not including the background image. In other words, by modifying the above described embodiments, the image processing system 1, without conducting a combination process of the changed image, may output the changed image or the image before change depending on the user. In this case, the image before change is one example of the first image specified in CLAIMS and the changed image is one example of the second image specified in CLAIMS. Alternatively, the image processing system 1 may combine, instead of the background image generated by the background image generating unit 204, the background image prepared in advance (for example, plain and unicolor background image, photograph and the like) with the changed image or the image before change to generate the image data for providing.

Although the image processing system 1 in the above described embodiments, based on the changed image and the image before change stored by the storage unit 205, generates the image data for providing, an embodiment is not limited to this. For example, by modifying the above described embodiments, the image processing system 1 may provide the image of the real time such as a live camera. In other words, the changed image generating unit 203 of the image processing system 1, for each browsing by the user, generates the changed image and the restoring unit 210, based on the changed image or the image before change, successively generates the image for providing. In this case, the image processing system 1 does not need to include the storage unit 205 and the recording unit 207.

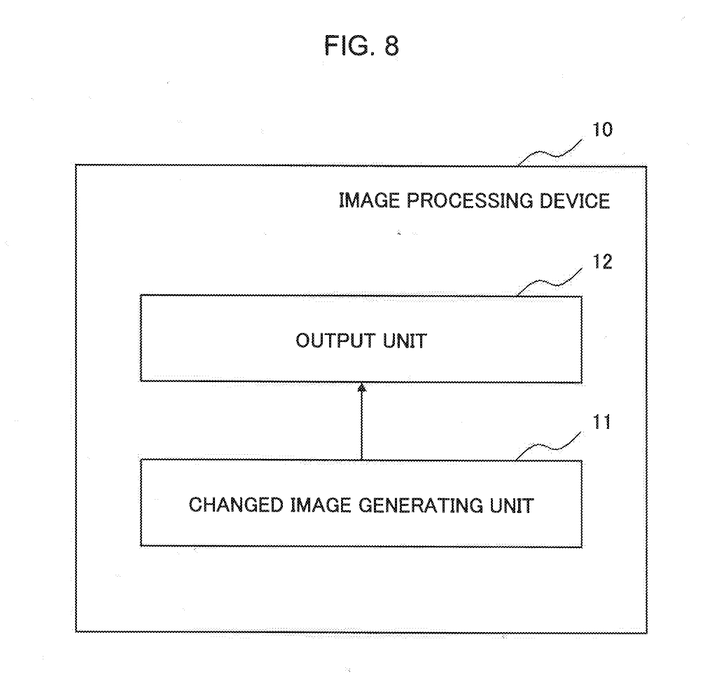

Next, basic configurations of an image processing device and an image restoring device of the present invention and basic processes of an image processing method and an image restoring method are described with reference to FIG. 8 to FIG. 11.

FIG. 8 is a block diagram illustrating a basic configuration of an image processing device 10. Although in the above described embodiments, the cloud server 200 and the edge server 300 that are one example of the image processing device 10 are described, the basic configuration of the image processing device 10 is as illustrated in FIG. 8. In other words, the image processing device 10 includes a changed image generating unit 11 and an output unit 12.

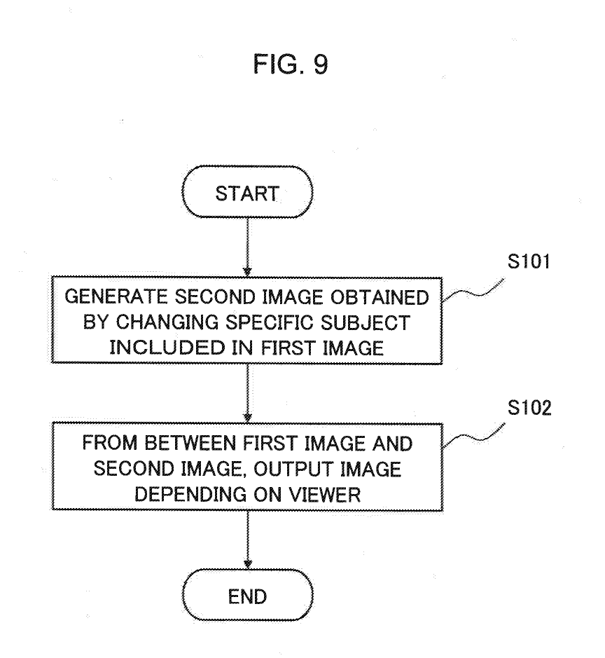

FIG. 9 is the flowchart illustrating basic processes of the image processing method. The changed image generating unit 11 of the image processing device 10 generates the second image obtained by changing the specific subject included in the first image (step S101). The output unit 12 outputs either one of the first image and the second image depending on the viewer (step S102).

Accordingly, the image processing device 10, depending on the purpose of use of the viewer, can provide the image data in which the disclosure amount of the attribute information of the target is adjusted. Note that the above described changed image generating unit 203 is one example of the changed image generating unit 11. Further, the above described image transmission unit 211 is one example of the output unit 12.

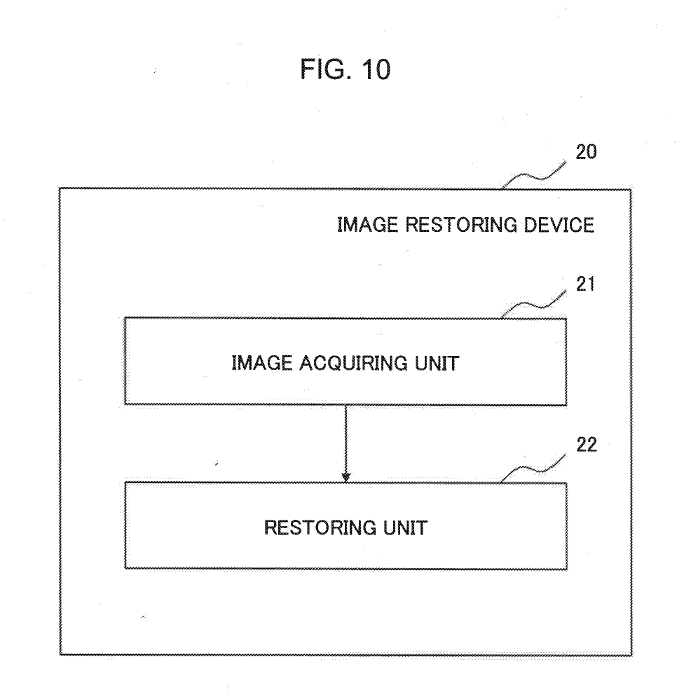

FIG. 10 is a block diagram illustrating a basic configuration of an image restoring device 20. Although in the above described embodiments, as one example of the image restoring device 20, the cloud server 200 has been described, the basic configuration of the image restoring device 20 is as illustrated in FIG. 10. In other words, the image restoring device 20 includes an image acquiring unit 21 and a restoring unit 22.

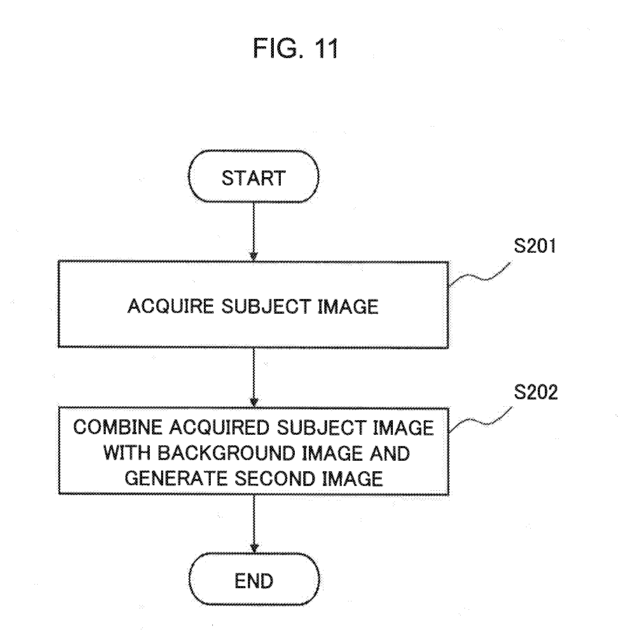

FIG. 11 is the flowchart illustrating the basic processes of the image restoring method. First, the image acquiring unit 21 acquires the subject image (step S201). The image acquiring unit 21 combines the subject image with the background image to generate the second image (step S202). Accordingly, the image restoring device 20, depending on the purpose of use of the viewer, adjusts the disclosure amount of the attribute information of the target, generates the second image, and provides the generated second image to the user. Note that the above described image acquiring unit 209 is one example of the image acquiring unit 21 and the above described restoring unit 210 is one example of the restoring unit 22.

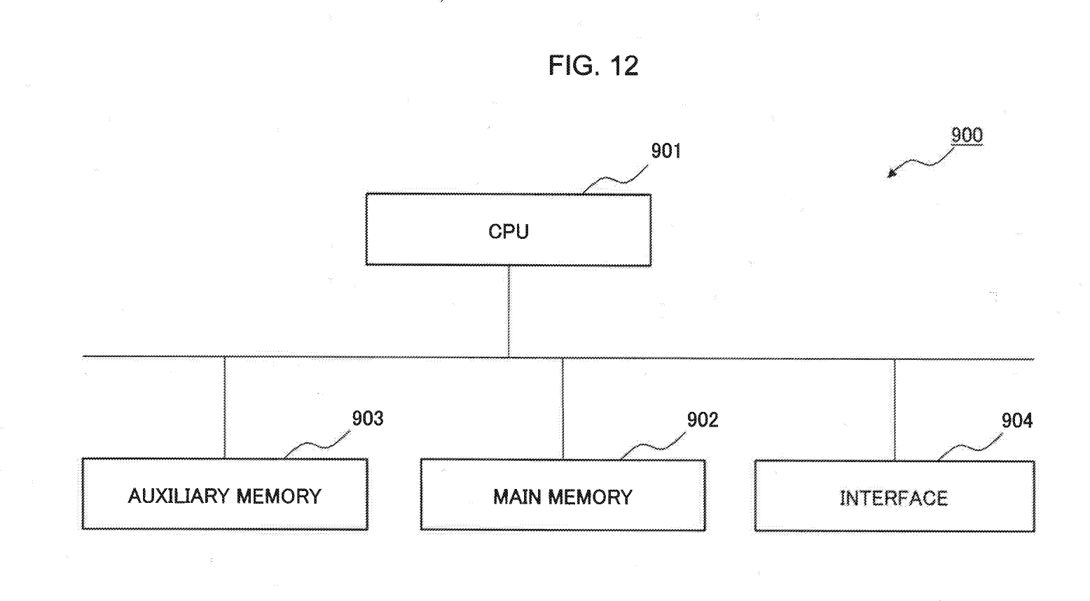

FIG. 12 is a block diagram of a computer 900 that can implement the image processing function and the image restoration function of the present invention. The computer 900 includes a CPU 901, a main memory 902, an auxiliary memory 903, and an interface 904. The above described function of the cloud server 200 and the function of the edge server 300 are implemented by the computer 900. The operations of the above described components 201 to 212 are stored in the auxiliary memory 903 in a program format. The CPU 901 reads the program from the auxiliary memory 903, expands the program to the main memory 902, and in accordance with the program, conducts the above described processing procedures. Further, the CPU 901, in accordance with the program, ensures the storage area corresponding to the storage unit 205 to the auxiliary memory 903.

In the computer 900, the auxiliary memory 903 is one example of a concrete storage medium that is not temporary. The concrete storage medium that is not temporary includes a magnetic disk, a magneto-optical disk, a CD-ROM, a DVD-ROM, a semiconductor memory and the like that are connected via an interface. Further, when the above described program is, via a communication line, distributed to the computer, the computer 900 may expand the program to the main memory 902 and conduct the above described processing procedures.

The above described program may realize a part of the image processing function and the image restoration function of the present invention. Further, the above described program may be a differential program (or differential file) that realizes the image processing function and the image restoration function of the present invention in combination with other programs already installed in the auxiliary memory 903.

Finally, a configuration and a function of the present invention are not limited to the above described embodiment and variation, and a design change and a modification within the scope of the invention specified in accompanying CLAIMS can be encompassed.

### INDUSTRIAL APPLICABILITY

The present invention relates a technique of controlling attribute information of the target included in image data depending on a viewer. Although in the above described embodiments, the image processing and the image restoration processes are implemented by the cloud server and the edge server, the imaging processes and the image restoration processes can be implemented by other systems and other devices. Further, it is possible to control the attribute information of the target included, in not only the image data but also in the sentence data and the voice data depending on the user.

### REFERENCE SIGNS LIST

1 Image processing system
10 Image processing device
11 Changed image generating unit
12 Output unit
20 Image restoring device
21 Image acquiring unit
22 Restoring unit
100 Terminal device
200 Cloud server
201 Image receiving unit
202 Area specifying unit
203 Changed image generating unit
204 Background image generating unit
205 Storage unit
206 Key generation unit
207 Recording unit
208 Key input unit
209 Image acquiring unit
210 Restoring unit
211 Image transmission unit
212 Condition input unit
300 Edge server

What is claimed is:

1. An image processing device comprising:
changed image generating unit configured to generate a second image obtained by changing a specific subject included in a first image; and
output unit configured to output either one of the first image or the second image depending on a viewer.

2. The image processing device according to claim 1, wherein
the changed image generating unit can generate a plurality of second images; and
the output unit outputs any one of the first image and the plurality of second images depending on the viewer.

3. The image processing device according to claim 1, wherein
the changed image generating unit changes a subject image corresponding to the specific subject; and
the output unit outputs the subject image depending on the viewer.

4. The image processing device according to claim 1, further comprising:
background image generating unit configured to generate a background image obtained by eliminating a subject image from the first image, wherein
the changed image generating unit changes the subject image corresponding to the specific subject.

5. The image processing device according to claim 2, wherein the plurality of second images can respectively recognize a different attribute concerning the specific subject.

6. The image processing device according to claim 3, wherein
when the first image includes a plurality of targets, the changed image generating unit respectively changes a plurality of subject images corresponding to the plurality of targets.

7. The image processing device according to claim 1, wherein the second image displays attribute information of the target.

8. The image processing device according to claim 1, wherein the second image includes a definition that is lower than that of the first image.

9. The image processing device according to claim 1, wherein the second image conceals a part of information concerning the target.

10. The image processing device according to claim 4, further comprising:
restoring unit configured to combine the background image with the subject image and generating the second image.

11. The image processing device according to claim 10, wherein the restoring unit generates the second image using the subject image that can recognize attribute information depending on the viewer.

12. The image processing device according to claim 10, further comprising:
storage that stores a plurality of subject images that are encrypted using a plurality of different encryption keys; and
key input unit configured to input at least one of the encryption keys; wherein
the restoring unit, among the plurality of subject image stored by the storage unit, generates the second image using the subject image that can be decrypted by the at least one of the encryption keys input by the key input unit.

13. The image processing device according to claim 12, wherein
when a plurality of encryption keys is input by the key input unit, the restoring unit decrypts only the subject image that can be decrypted by all encryption keys and generates the second image.

14. The image processing device according to claim 1, further comprising:
storage that stores the first image and the second image that are respectively encrypted by different encryption keys.

15. The image processing device according to claim 12, further comprising:
key generation unit configured to generate the encryption keys based on feature information of the target.

16. The image processing device according to claim 15, further comprising:
condition input unit configured to input a third image including the subject image instead of the key input unit for inputting the encryption key; wherein
the key generation unit generates, from the third image, the encryption key; and
the restoring unit, among the plurality of subject images stored by the storage unit, generates the second image using the subject image that can be decrypted by the encryption key generated from the third image.

17. (canceled)

18. An image processing method comprising:
generating a second image obtained by changing a specific subject included in a first image; and
outputting either one of the first image or the second image depending on a viewer.

19. (canceled)

20. An image restoring device comprising:
image acquiring unit configured to acquire a subject image corresponding to a specific subject included in a first image; and
restoring unit configured to combine a background image obtained by eliminating, from the first image, the subject image with the subject image and generating a second image.

21. (canceled)

22. (canceled)

23. (canceled)
